(19) United States
(12) Patent Application Publication
(10) Pub. No.: US 2004/0027657 A1
(43) Pub. Date: Feb. 12, 2004

(54) Binoculars

(75) Inventor: Carl Steiner, Bindlach (DE)

Correspondence Address: BROWDY AND NEIMARK, P.L.L.C., 624 NINTH STREET, NW, SUITE 300, WASHINGTON, DC, 20001-5303, US

(73) Assignee: STEINER-OPTIK GMBH, Bayreuth (DE)

(21) Appl. No.: 10/632,845

(22) Filed: Aug. 4, 2003

(30) Foreign Application Priority Data
Aug. 3, 2002 (DE) 102 35 553.3

(51) Int. Cl. G02B 23/00

(52) U.S. Cl. 359/407

(57) ABSTRACT

In binoculars comprising an objective lens, a prism arrangement and an eyepiece, it is provided that a mirror can be inserted in the optical path between the prism arrangement and the eyepiece, deviating the optical path to an image sensor of a digital camera arrangement.

### BACKGROUND OF THE INVENTION

1. Field of the Invention

The invention relates to binoculars comprising an objective lens, a prism arrangement and an eyepiece. Provision is in particular made for binoculars that excel by excellent optical properties.

1. Background Art

Binoculars of the generic type are used for military purposes on the one hand and for civilian purposes on the other, in particular in navigation, hunting and wildlife observation.

For documentation in addition to pure observation, telephoto-lens cameras have been used, which means the binoculars must be put aside and a camera must be taken; problems are posed, in addition to the tiresome task of handling two devices, by the difficulty of locating, through the camera lens, an observed animal, for instance a bird, after changing the binoculars for a camera.

Fundamentally, it has been known to use high-quality binoculars or telescopes as telephoto lenses for cameras by intercalation of corresponding adapters, or to combine binoculars with photographic cameras. These products have been described for example in DE 38 09 656 A1, EP 0 908 751 A2, U.S. Pat. No. 5,581,399 A, U.S. Pat. No. 4,255,765 A and U.S. Pat. No. 5,963,369 A.

### SUMMARY OF THE INVENTION

It is an object of the invention to combine high-quality binoculars with a digital camera in such a way that the optical properties of the binoculars and observation quality will not be affected while adequate working of the camera is maintained.

According to the invention, this object is attained in that a mirror can be inserted in the optical path of the binoculars between the prism arrangement and eyepiece, deviating the optical path to an image sensor of a digital camera.

This means that, without insertion of a mirror in the optical path, standard working of the binoculars is ensured without any restriction. If camera function is desired, the mirror is inserted in the optical path, enabling photos to be taken as though by a camera with full use of light transmitting capacity.

In keeping with the invention, provision is made for the mirror to be pivotable into the optical path, in particular by way of a coulisse.

The coulisse bilaterally comprises a rear guiding slot and a curved front guiding slot, with lateral front and rear guiding pins being disposed on the mirror, which laterally engage with the guiding slots.

In keeping with an advantageous embodiment, the motion of insertion of the mirror into the optical path is mechanically coupled with the release.

Preferably, the force of release for picture recording exceeds the force of holding the mirror in a stop position. Once the mirror has reached a stop position, increased resistance must be overcome in order to release picture recording.

Further provision can be made for the mirror, after termination of recording, to be reset from the optical path by spring load.

For little overall height and an upright picture to be obtained, a stationary deviation mirror may be provided between the movable deviation mirror and the image sensor of the digital camera arrangement; for optimal imaging, a lens arrangement may be provided between the movable deviation mirror and the stationary deviation mirror on the one hand and between the stationary deviation mirror and the image sensor on the other.

Details of the invention will become apparent from the ensuing description of a preferred embodiment, taken in conjunction with the drawing.

### BRIEF DESCRIPTION OF THE DRAWING

FIG. 1 is an illustration of the optical path in binoculars according to the invention;

FIG. 2 is a diagrammatic perspective view of the area around the deviation mirror; and

FIG. 3 is a diagrammatic view of the releasing and resetting arrangement.

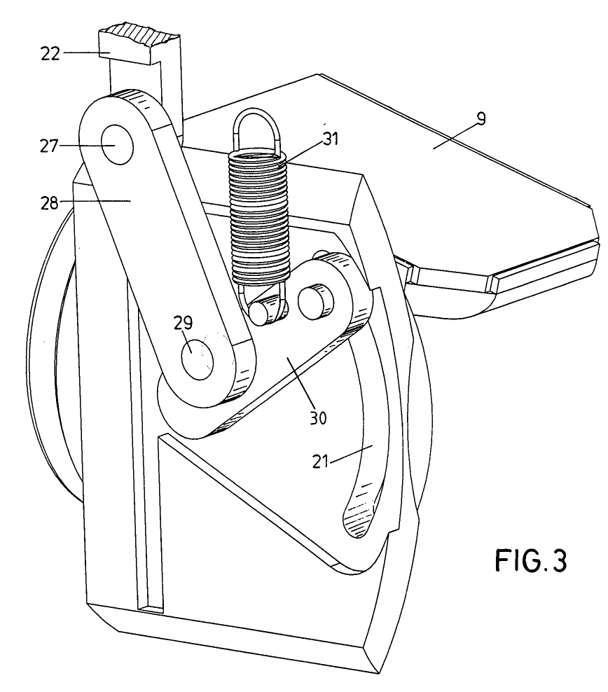

### DESCRIPTION OF THE PREFERRED EMBODIMENT

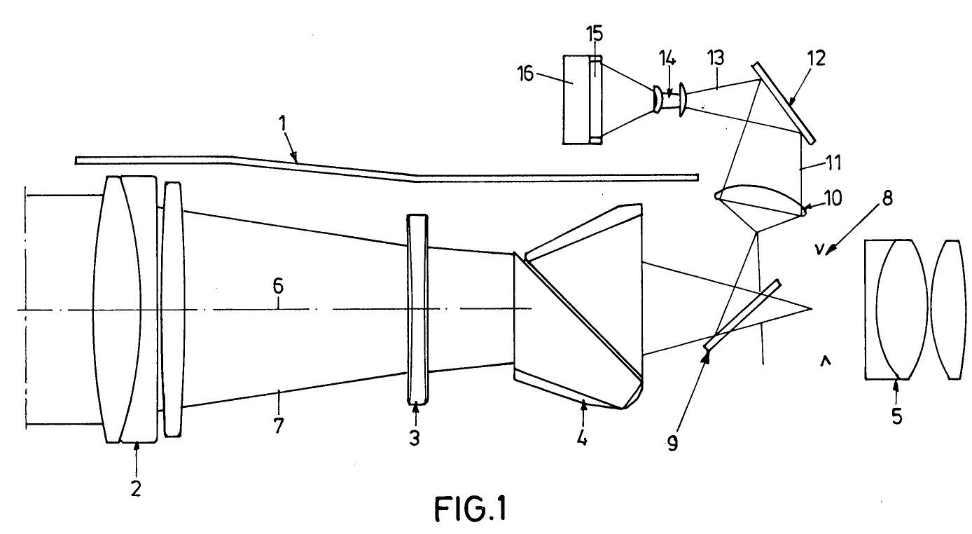

FIG. 1 diagrammatically illustrates a casing 1 in which provision is made for an objective lens 2 with a downstream lens 3, followed by a prism arrangement 4 and an eyepiece 5.

The above optical elements are disposed on a common central longitudinal axis 6, forming an optical path 7 that leads to the field stop 8 in front of the eyepiece 5.

A deviation mirror 9, which can be inserted in the optical path 7, is disposed between the prism arrangement 4 and the eyepiece 5 in the optical path 7; an imaging lens 10 is disposed downstream of the mirror 9, directing an optical path 11 to a stationary deviation mirror 12, from where an optical path 13 leads to a lens arrangement 14 that images the deviated picture on the image sensor 15 of a digital camera arrangement 16.

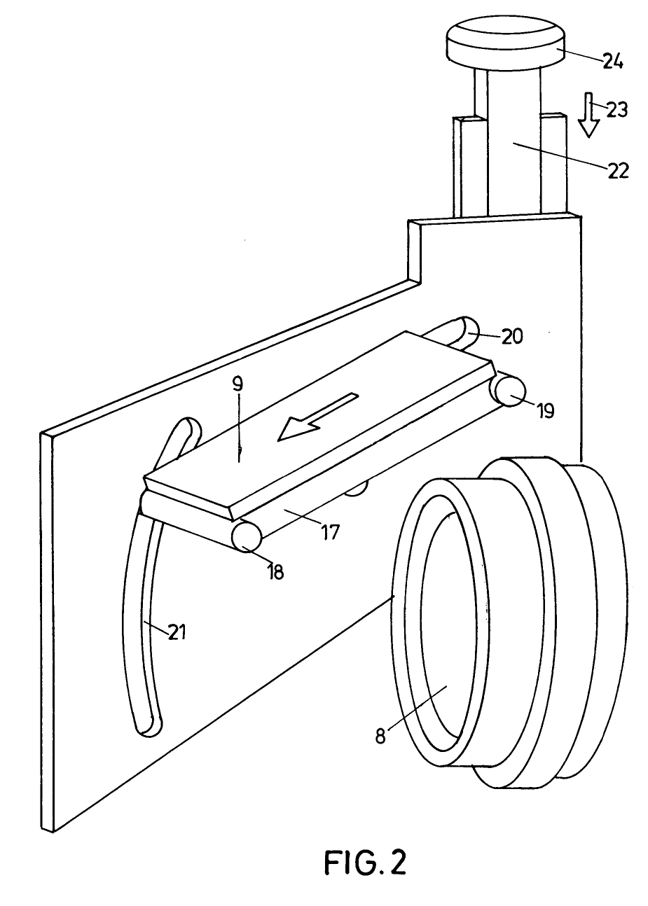

As seen in FIG. 2, the mirror 9 is disposed on a mirror support 17 which has front guiding pins 18 and rear guiding pins 19 which stand out on both sides of the mirror support 17 and engage with bilateral rear guiding slots 20 and curved front guiding slots 21 so that, upon displacement of the mirror support 17 in the direction of the arrow i.e. forwards in FIG. 2, the mirror 9 is pivoted downwards into the optical path 7. This motion is induced by mechanical coupling with a release 22 when the release is pressed down in the direction of the arrow 23 by the aid of the button 24. This coupling is implemented by the release 22 being joined via a link 27 to a deviation lever 28 that acts via a link 29 on an adjusting lever 30 which is connected to the deviation mirror 9 and guided by way of the mentioned guiding slot 21. Resetting the deviation mirror 9 takes place by way of the helical spring 31. For video recording, resetting may be blocked until the recording job has been terminated i.e., a lock (not shown) will then be released deliberately.

The above specification shows that, as long as the deviation mirror 9 is not inserted in the optical path 26 between the prism arrangement 4 and the eyepiece 5, conventional binocular optics are available which may be equipped with reliable standards and techniques, consequently furnishing excellent image quality accompanied with high magnification.

If however the mirror 9 is inserted in the optical path 26, camera function takes over and the entire optical path 26 is deviated towards the image sensor 15 of the digital camera arrangement 16, with the stationary deviation mirror 12 providing for an upright image that appears correctly in the viewfinder, and ensuring little overall height.

For adaptation of the binoculars to individual eye defects or bad eyesight, correction is possible by the aid of the focusing lens in the vicinity of the objective lens or by the eyepiece. Individual corrections may result in a blurred image on the sensor 15 of the camera. For this to be avoided, the sensor 15 can be displaceable along the principal axis of the optical path; this displacement is preferably coupled with the correction made for individual adaptation to the user, acuity of the image on the sensor 15 thus being automatically attained.

What is claimed is:

1. A pair of binoculars, comprising an objective lens (2), a prism arrangement (4) and an eyepiece (5), wherein a mirror (9) can be inserted in an optical path (7) between the prism arrangement (4) and the eyepiece (5), deviating the optical path (7) to an image sensor (15) of a digital camera arrangement (16).

2. A pair of binoculars according to claim 1, wherein the mirror (9) is pivotable into the optical path (7).

3. A pair of binoculars according to claim 2, wherein the mirror (9) is pivotable via a coulisse (20, 21).

4. A pair of binoculars according to claim 3, wherein the coulisse (20, 21) bilaterally comprises a rear guiding slot (20) and a curved front guiding slot (21), with lateral front and rear guiding pins (18, 19) being disposed on the mirror (9), which laterally engage with the guiding slots (20, 21).

5. A pair of binoculars according to claim 1, wherein insertion of the mirror (9) in the optical path (7) is mechanically coupled with a release (22).

6. A pair of binoculars according to claim 5, wherein a force of release for picture recording exceeds a force of holding the mirror (9) in a stop position.

7. A pair of binoculars according to claim 6, wherein once the mirror has reached the stop position, increased resistance must be overcome in order to release picture recording.

8. A pair of binoculars according to claim 5, wherein the mirror (9) is reset from the optical path (7) by spring load.

9. A pair of binoculars according to claim 1, wherein a stationary deviation mirror (12) is disposed between the movable deviation mirror (9) and the image sensor (15) of the digital cameral arrangement (16).

10. A pair of binoculars according to claim 9, wherein a lens arrangement (10) is provided between the movable deviation mirror (9) and the stationary deviation mirror (12).

11. A pair of binoculars according to claim 9, wherein a lens arrangement (14) is provided between the stationary deviation mirror (12) and the image sensor (15).
